(19) United States
(12) Patent Application Publication
(10) Pub. No.: US 2019/0214867 A1
(43) Pub. Date: Jul. 11, 2019

(54) ELECTRIC MOTOR HAVING A DIAMETRIC COIL

(71) Applicant: VASTECH HOLDINGS LTD., London (GB)

(72) Inventors: Alexander MOSTOVOY, Ashkelon (IL); Victor Shlakhetski, Ashkelon (IL)

(73) Assignee: INTELLITECH PTY LTD, Malvern, Victoria (AU)

(21) Appl. No.: 16/327,617

(22) PCT Filed: Dec. 15, 2016
(86) PCT No.: PCT/IL2016/051342

§ 371 Date: Feb. 22, 2019

(30) Foreign Application Priority Data
Sep. 29, 2016 (GB) 1616560.7

(51) Int. Cl. H02K 1/27; H02K 1/14; H02K 21/18; H02K 11/215

(52) U.S. Cl. CPC H02K 1/2766; H02K 1/278; H02K 11/215; H02K 21/18; H02K 1/146

(57) ABSTRACT

The invention relates to an electric motor, which comprises: (A) a disk-type rotor which comprises: (a) a co-centric shaft and disk; (b) two or more permanent magnets on top or within said disk; and (c) pieces of ferromagnetic material that are disposed between at least two of said permanent magnets; and, (B) a stator which comprises: (d) a diametric coil unit which is disposed along a diameter of the rotor's disk, the coil unit comprises: (d1) a diametric rectangular bobbin having a rectangular cavity, said rectangular cavity having a length slightly larger than the diameter of the rotor; (d2) a coil which is wounded around said diametric bobbin; and (d3) upper and lower holes within said bobbin to contain said shaft, thereby to allow rotation of said rotor within the said rectangular cavity.

### FIELD OF INVENTION

The invention relates to the field of electric motors. More specifically, the invention relates to an electric motor which comprises one or more diametric coils that are placed at the stator, and two or more permanent magnets that are placed on a disk-type rotor.

### BACKGROUND OF THE INVENTION

Electric motors of the rotational type are well known, and have been widely used for many years now for converting electrical energy to mechanical energy. A typical electric motor comprises a rotor and a stator.

The rotor is the moving part of the motor, and it comprises the turning shaft which delivers the rotation to a load. The rotor usually has conductors laid into it, which carry currents that interact with the magnetic field of the stator to generate the forces that turn the shaft. In another alternative, the rotor comprises permanent magnets, while the conductors are provided at the stator.

The stator, in turn, is the stationary part of the motor's electromagnetic circuit, and it usually has either windings or permanent magnets. The stator bobbin is typically made up of many thin metal sheets, called laminations. Laminations are used to reduce energy losses that would otherwise result if a solid bobbin were used.

Electric motors are also used in a reversed functionality to convert mechanical energy to electric energy, and in such a case, the electric motor is in fact an electric generator.

While the electrical motor operates to convert electrical energy to mechanical energy, a parasitic magnetic flux is produced within the electrical motor, resulting in the generation of electric force called CEMF (Counter Electro-Motive Force), in addition to the production of the desired mechanical energy. This parasitic electric force (Lenz's Law) in fact reduces the total mechanical energy which is obtained from the motor. Due to the CEMF, the parasitic electric energy that is produced within the motor may reach up to 80% of the total energy at 3000 Rpm and 20% at 1000 Rpm. All attempts to eliminate this amount of parasitic energy, which is inherent to the structure of the typical electric motor, have reached some limit, but they could not eliminate this parasitic energy entirely.

U.S. Pat. No. 8,643,227, by Takeuchi discloses a linear motor which uses a permanent magnet that moves within a coil. U.S. Pat. No. 8,030,809 (Horng et al) discloses a stator for a brushless motor which includes an annular insulating ring. U.S. Pat. No. 6,252,317 discloses an electric motor which includes a plurality of coils through which passes a ring rotor having a plurality of magnets supported thereon.

WO 2013/140400 and WO 2014/147612 by same Applicant and inventors as of the present invention, teach ring-type electrical motors. In each of said motors, the rotor comprises a plurality of permanent magnets that are arranged in a ring-type arrangement, while the rotation is effected by means of a plurality of coils that are disposed at the stator. The direction of the DC current passing through each of the motor coils has to be inverted several times during each disk rotation, in synchronization with the pole of the permanent magnet which faces a respective coil. The rate of the current-direction inversions clearly increases as the number of coils increases, and as the motor speed (measured by rounds-per-minute—RPM) increases. Therefore, in high rotation speeds (for example, 3000 rounds per minute), the rate of the current inversions becomes very high, resulting in an increase of the cost and complication of the motor's controller. Furthermore, a high current-direction inversion rate, while it increases the speed of the motor, results in a higher CEMF, and a reduction in the efficiency of the motor.

It is therefore an object of the invention to provide an electrical motor having a simple and inexpensive structure. More specifically, the invention provides a motor structure which can operate even with single coil at the stator.

It is another object of the present invention to provide a brushless electric motor having a simple structure, which can deliver a torque to an external load with no requirement for the use of a gear.

It is another object of the invention to reduce the number of current-direction inversions to the motor's coils for a given motor speed, thereby to reduce the complication and cost of the motor controller.

It is still another object of the present invention to provide a new structure of an electric motor in which the parasitic energy, which is caused in prior art motors due to a reversed magnetic flux (CEMF), is substantially reduced.

It is still another object of the invention to provide an electric motor which can operate at a higher speed of rotation compared to prior art motors, in view of a higher efficiency and reduction of the CEMF.

It is still another object of the invention to provide a safer electrical motor, which requires supply of low current to each of its one or more coils.

Other objects and advantages of the invention will become apparent as the description proceeds.

### SUMMARY OF THE INVENTION

The invention relates to an electric motor, which comprises: (A) a disk-type rotor which comprises: (a) a co-centric shaft and disk; (b) two or more permanent magnets on top or within said disk; and (c) pieces of ferromagnetic material that are disposed between at least two of said permanent magnets; and, (B) a stator which comprises: (d) a diametric coil unit which is disposed along a diameter of the rotor's disk, the coil unit comprises: (d1) a diametric rectangular bobbin having a rectangular cavity, said rectangular cavity having a length slightly larger than the diameter of the rotor; (d2) a coil which is wounded around said diametric bobbin; and (d3) upper and lower holes within said bobbin to contain said shaft, thereby to allow rotation of said rotor within the said rectangular cavity.

In an embodiment of the invention, said rotor comprises a non-ferromagnetic lower disk, and wherein said permanent magnets are equi-angularly spaced and equi-radially disposed on said lower disk in a partial ring-like structure, and wherein ferromagnetic-material pieces are disposed between at least two of said permanent magnets to form a partial or closed ring-like structure.

In an embodiment of the invention, when two of said permanent magnets are used, they are disposed along a diameter of said lower disk.

In an embodiment of the invention, when two of said permanent magnets are used, similar poles of the permanent magnets face one another, respectively.

In an embodiment of the invention, when a partial ring-like structure is formed, an air space is provided between each of one or more pairs of permanent magnets.

In an embodiment of the invention, the rotor further comprises an upper disk of non-ferromagnetic material, for strengthening the structure of the rotor.

In an embodiment of the invention, said disk-type rotor comprises a ferromagnetic-material disk, wherein the two or more permanent magnets are equi-angularly spaced and equi-radially disposed within dedicated slots in said disk.

In an embodiment of the invention, the motor further comprises a motor controller for periodically alternating a direction of a DC current which is supplied to said coil.

In an embodiment of the invention, the motor further comprises one or more angular orientation sensors, for feeding a respective orientation signal into said motor controller.

In an embodiment of the invention, said one or more angular orientation sensors are disposed on the motor's shaft.

In an embodiment of the invention, said one or more angular orientation sensors are disposed within the bobbin of the diametric coil unit.

In an embodiment of the invention, the motor comprises a two level rotor, wherein all the components of the second rotor-level, including its permanent magnets and its diametric coil are shifted 90° relative to similar components in the first rotor's level.

### BRIEF DESCRIPTION OF THE DRAWINGS

In the drawings:

FIG. 1 illustrates a general structure of the motor, according to an embodiment of the invention;

FIGS. 2a, and 2b illustrate a basic structure of the motor's rotor, according to a first embodiment of the invention;

FIG. 3 illustrates a basic structure of the motor's rotor, according to a second embodiment of the invention;

FIGS. 4a and 4b show a rotor structure 220 according to a third embodiment of the invention;

FIG. 5 is a front view of the bobbin of the coil unit of the invention;

FIG. 6 illustrates the structure of a two-level rotor, according to a fourth embodiment of the invention; and

FIG. 7 illustrates the structure of the motor of the invention which was tested in Example 1.

### DETAILED DESCRIPTION OF PREFERRED EMBODIMENTS

As noted above, the rate of inversions of the current-direction to the coils of the motor must be increased as the number of coils at the stator increases, and as the speed of rotation of the rotor increases. This increase of the rate of the current-direction inversion requires a more complicated and expensive motor controller, and results a reduction in the efficiency of the motor. More specifically, an increased switching frequency requires a more powerful power driver at the motor controller, which inevitably increases the power loss during switching of the current direction. It is therefore an object of the invention to provide a motor which can operate even with a single coil at the stator, in which the rate of current-direction inversions is significantly reduced for a given speed of rotation (in rounds-per-minute).

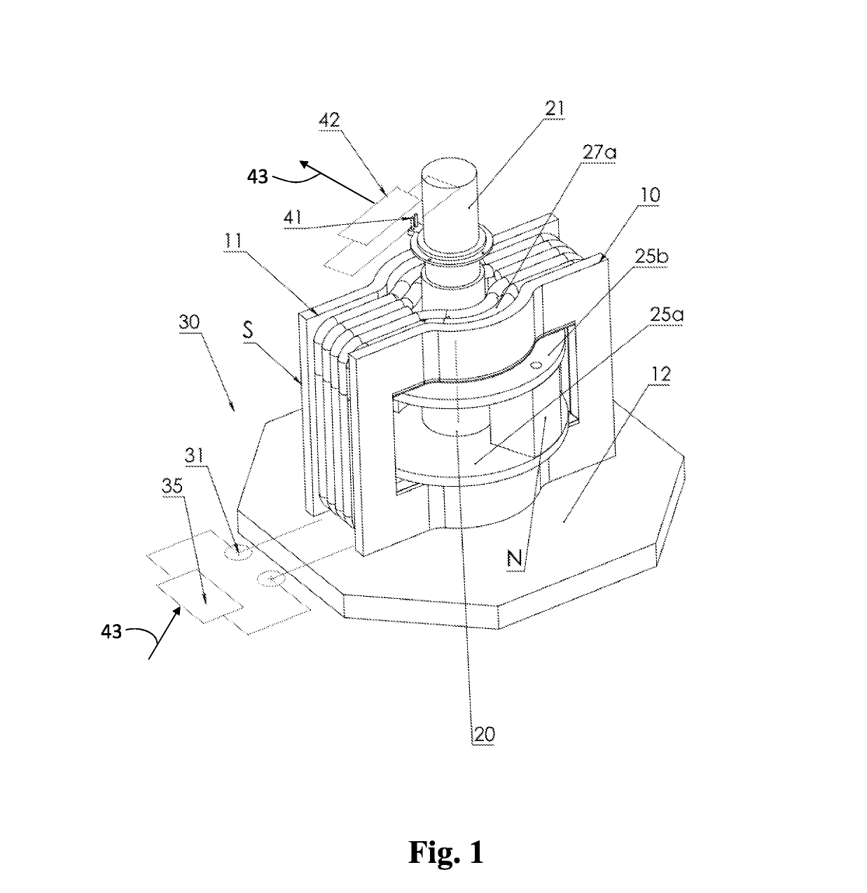

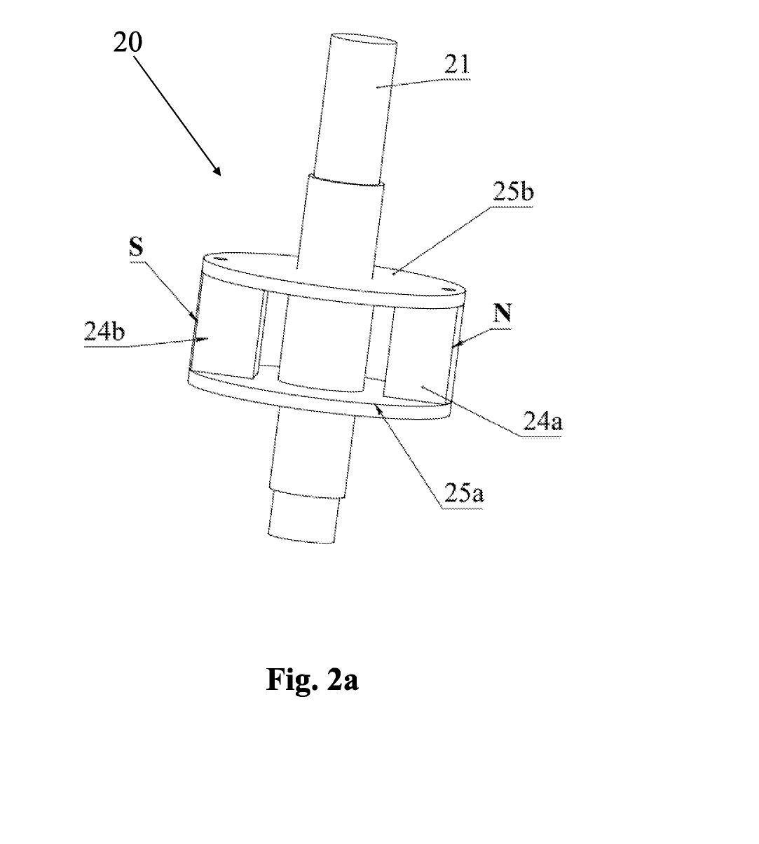

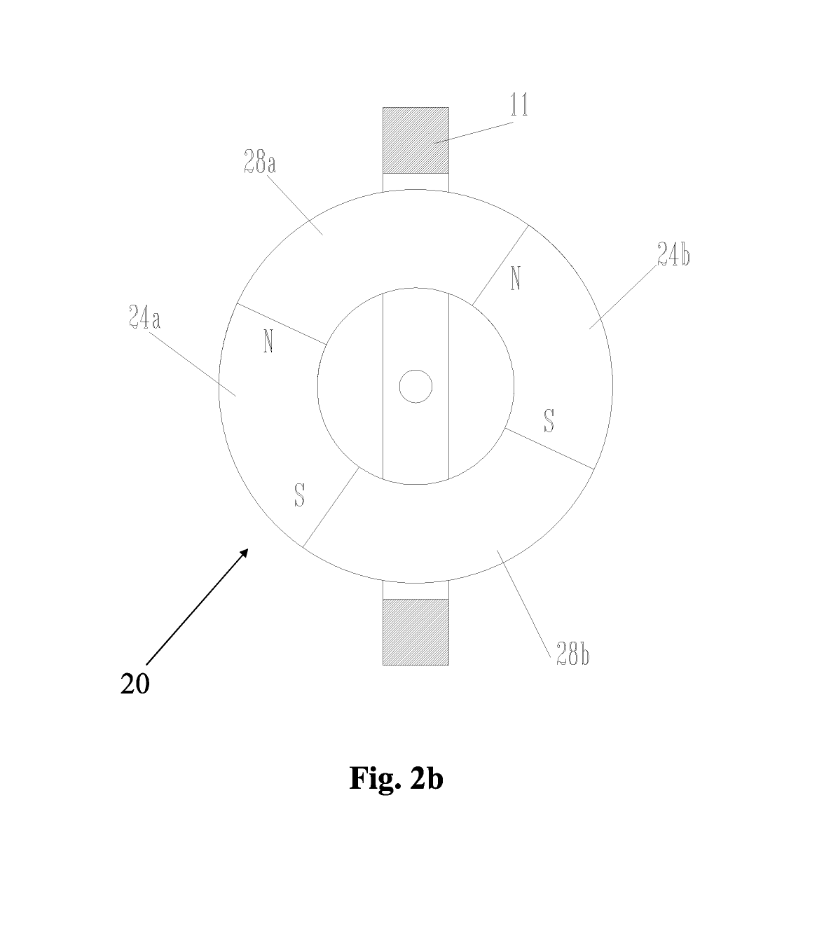

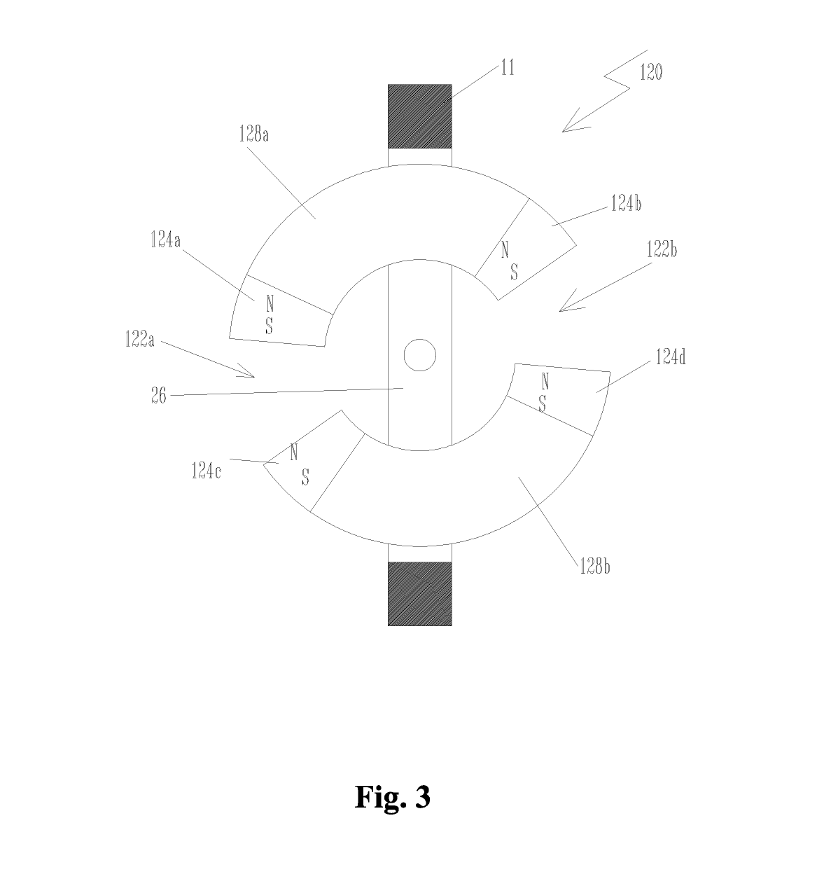

FIG. 1 illustrates a general structure of motor 10, according to an embodiment of the invention. FIGS. 2a, and 2b illustrate a basic structure of the rotor 20 of the motor, according to a first embodiment of the invention. FIG. 3 illustrates a basic structure of the rotor 20 of the motor, according to a second embodiment of the invention.

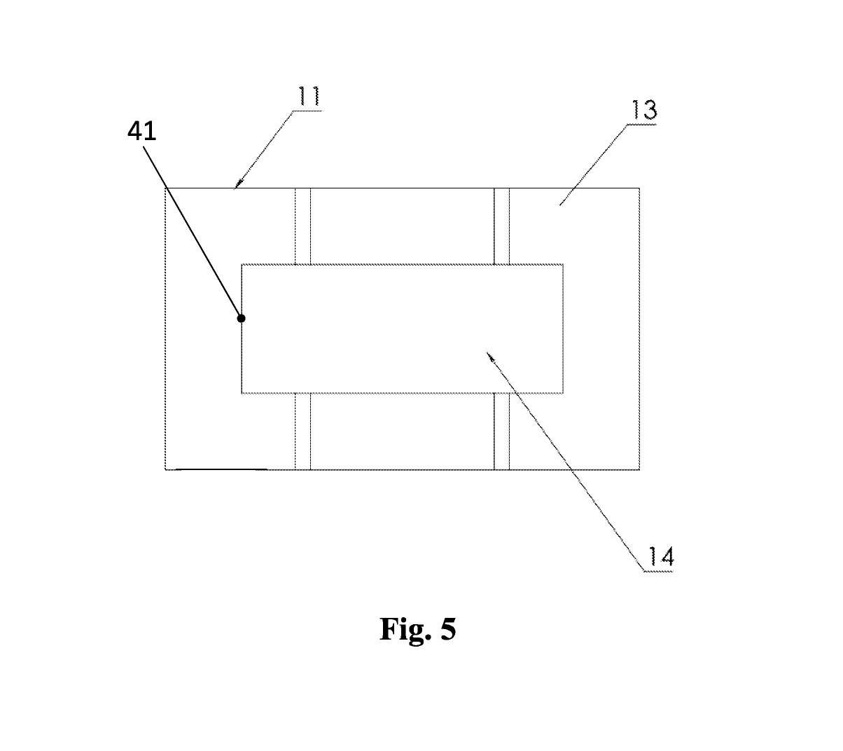

The stator 30 of the motor comprises a diametric coil unit 11 which is mounted on a rigid support 12. The diametric coil unit 11 is mounted on a diameter of disk 25a, and spans the entire diameter of the rotor's disk. As shown in FIGS. 1 and 5, the diametric coil unit 11 comprises a substantially rectangular bobbin 13 (in front view), having a rectangular cavity 14 of a length slightly larger than the diameter of the rotor. For example, for a rotor having a diameter of 300 mm, the length of the cavity 14 may be between 305 and 310 mm.

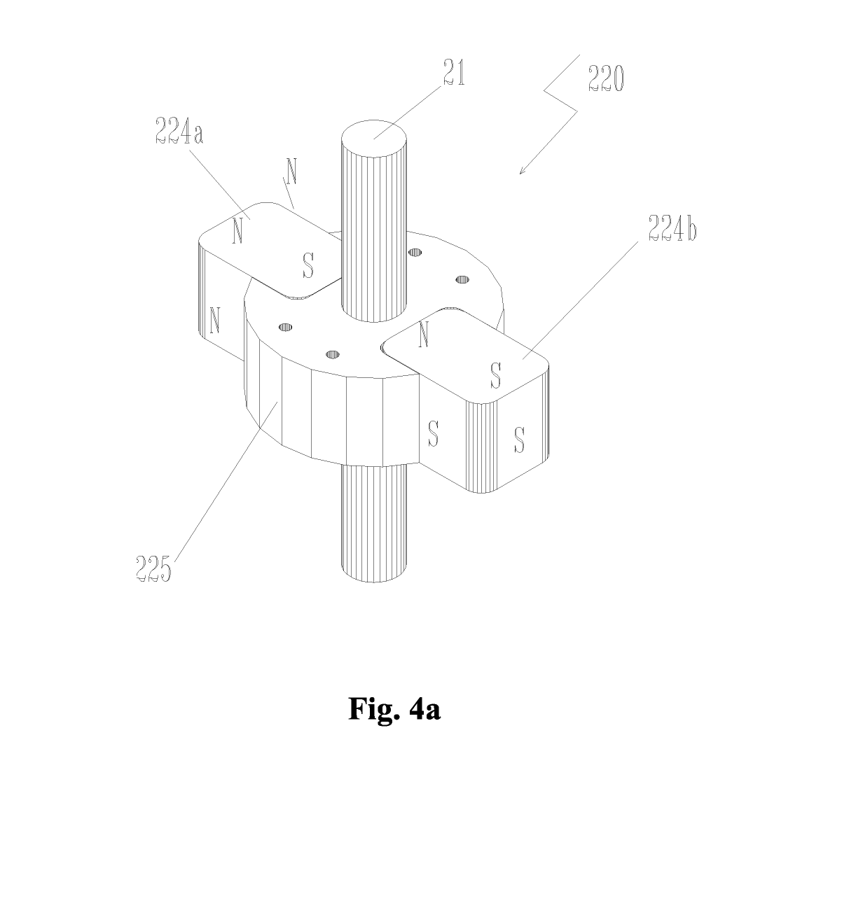

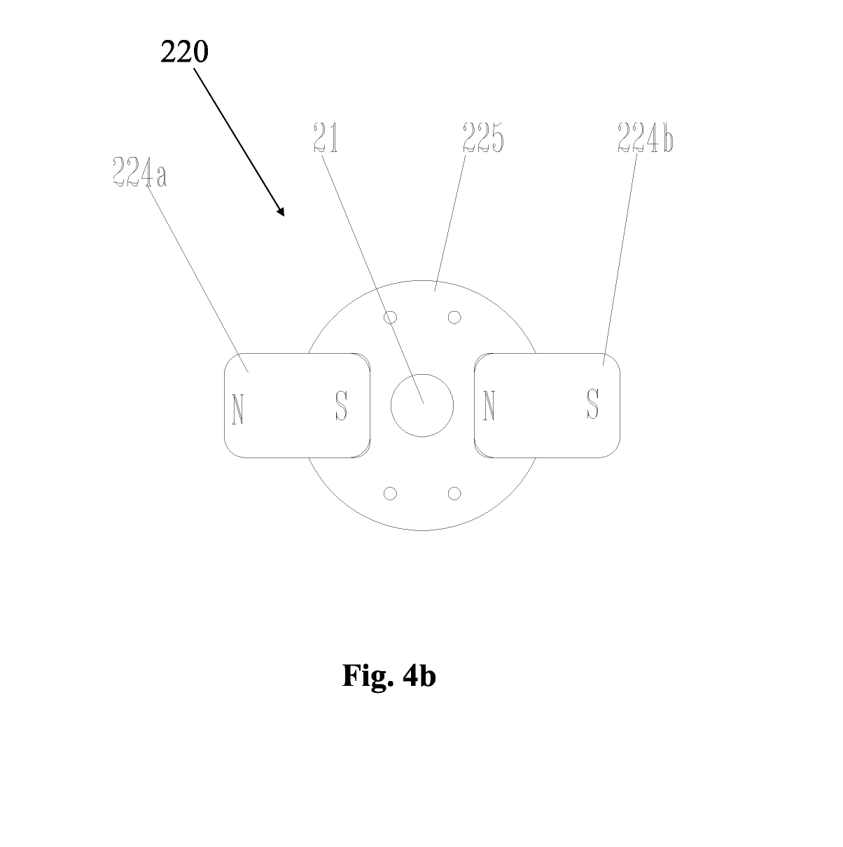

According to the present invention, the rotor 20 is of a disk-type rotor. By disk-type rotor it is meant that the rotor comprises either a lower disk (such as lower disk 25a shown in FIG. 1) on which a plurality of permanent magnets are mounted, or alternatively, the rotor comprises a disk (such as the disk 225 of FIG. 4a) having a plurality of radial slots, each containing one permanent magnet.

FIG. 2a shows the general structure of rotor 10, according to a first embodiment of the invention. FIG. 2b shows the manner of arrangement of the magnets in rotor 10. The rotor comprises a shaft 21, and two permanent magnets 24a and 24b that are mounted on a lower disk 25a. Said two permanent magnets are positioned symmetrically along a single diameter of disk 25a, while similar poles of the two magnets face one another, namely the N pole of magnet 24a faces the N pole of magnet 24b, and likewise, the S pole of magnet 24a faces the S pole of magnet 24b. Optional upper disk 25b, when exists, improves the mechanical strength of the rotor. Lower disk 25a and upper disk 25b (when exists) are made of a non-ferromagnetic material, such as aluminum or plastic. The shaft 21 passes through upper and lower openings at the upper and lower portions of bobbin 13, respectively (only upper opening 27a is shown in FIG. 1). FIG. 2b shows how the two permanent magnets 24a and 24b are arranged on the lower disk 25a. As shown, similar poles of the two magnets face one another (namely, the N pole of magnet 24a faces the N pole of magnet 24b, and similarly the S pole of magnet 24a faces the N pole of magnet 24b). Preferably, two optional arcuate pieces 28a and 28b of ferromagnetic material (such as iron), are disposed between the two permanent magnets 24a and 24b. As will be discussed hereinafter, said arcuate ferromagnetic pieces 28a and 28b (shown only in FIG. 2b), when exist, significantly reduce the CEMF the motor.

FIG. 3 shows a second embodiment of the rotor of the invention, as an alternative to magnets arrangement of FIG. 2b. The rotor 120 of FIG. 3 is similar in its structure to the rotor 20 of FIG. 2b, however, while the rotor 20 of FIGS. 2a and 2b comprises two permanent magnets, the rotor 120 of FIG. 3 comprises four permanent magnets 124a-124d. The permanent magnet 24a of FIG. 2b is divided into two smaller size permanent magnets 124a and 124c, and the permanent magnet 24b of FIG. 2b is divided into two smaller size permanent magnets 124b and 124d to form the arrangement of FIG. 3a. The accumulated volume of the two smaller magnets 124a and 124c is smaller than the volume of the magnet 24a (of FIG. 2b) alone, and similarly, the accumulated volume of the magnets 124b and 124d is smaller than the volume of magnet 24b (of FIG. 2b) alone. Air gaps 122a and 122b are provided in the arrangement of FIG. 3 between each of the pairs of separate smaller magnets 124a-124c, and 124b-124d. Such a division of each “large” permanent magnet 24a and 24b into two pairs of smaller magnets 124a-124c, and 124b-124d significantly reduces the total cost of the permanent magnets that are used in the rotor 120, and as a result, the entire cost of the rotor 120 is reduced compared to the cost of rotor 20 of FIG. 3b. It has been found that the performance of a motor having the rotor arrangement 120 of FIG. 3 is about the same as of the arrangement 20 of FIG. 2b.

FIGS. 4a and 4b show a rotor structure 220 according to a third embodiment of the invention. Rotor 220 comprises two permanent magnets 224a and 224b that are attached to an iron disk 225 within two dedicated slots. The poles of the magnets are as indicated in FIG. 4a. The effect of this permanent magnets and iron disk arrangement of FIG. 4a in terms of reduction of the CEMF is similar to the effect of the arrangements of FIGS. 2b and 3 (where two iron pieces 28a and 28b, or 128a and 128b respectively are provided between two pairs of permanent magnets). More specifically, in all the three rotor embodiment the existence of iron pieces between each pair of permanent magnets, respectively, results in a motor with a significant reduced CEMF compared to prior art equivalent motors.

In reference to FIG. 1, the coil 40 of the diametric coil unit 11 typically comprises between 10 and 20 windings. Motor controller 35 supplies DC current to the coil 40 via port 31. In order to assure a continuous rotation of the rotor (20, 120, or 220, whichever is used), the direction of the input current to the coil has to be periodically inverted, in synchronization with pole of the permanent magnet which is next to the coil unit. The synchronization is performed using sensor 41, for example, a Hall-type sensor, which is mounted on shaft 21, as best shown in FIG. 3. Sensor 41 may alternatively be positioned within the bobbin 13, as shown in FIG. 5. Sensor 41 may either sense the angular orientation of shaft 21 (and in that case is positioned close to the shaft), or a proximate existence of a permanent magnet (and in that latter case is positioned at a location which is periodically close to a permanent magnet). Sensing circuitry 42 provides a synchronization signal into the motor controller 35, which in turn alternates the direction of the DC current supply, accordingly. As noted, the sensor 41 senses the angular orientation of the rotor 20, particularly its permanent magnets orientation with respect to the diametric coil unit 11. The rotor orientation 43 (or a magnet proximity), as sensed, is conveyed to the motor controller 35, which in turn synchronizes the rotation of the motor by providing periodical DC current in an appropriate direction to coil 40. The supply of the DC current to the coil 40 causes a pulling force to one of the permanent magnet 24a, 124a, or 224a, respectively, and a pushing force to the other magnet 24b, 124d, or 224b, respectively. As previously mentioned, upon each passage of the permanent magnet through the cavity 14 of the bobbin 13 (FIG. 5), the existence of a permanent magnet is sensed by sensor 41, resulting in the inversion of the direction of the DC current (alternatively, the existence of the permanent magnet within the cavity 14 may be deduced from the orientation of the shaft 21). In such a manner the portion of the coil unit 11 which previously pulled a magnet 24a, 124a or 224a respectively now pushes it, and vice versa—the opposite portion of the coil unit 11 which previously pulled the other magnet 24b, 124d or 224b now pushes it, resulting in a continuous rotation of the rotor 20.

As noted, two optional arcuate pieces of ferromagnetic material (such as iron) 28a (or 128a) and 28b (or 228b), respectively, are disposed between the two permanent magnets 24a (or 124a) and 24b (or 124b) as best shown in FIGS. 2b and 3, respectively. Alternatively, in the third embodiment of FIG. 4a, the iron disk 225 serves the same object as of said iron pieces of FIGS. 2a and 3.

As shown, the motor of the invention as described so far comprises only a single diametric coil. Therefore, the rate of the current-direction inversions to the coil is minimized.

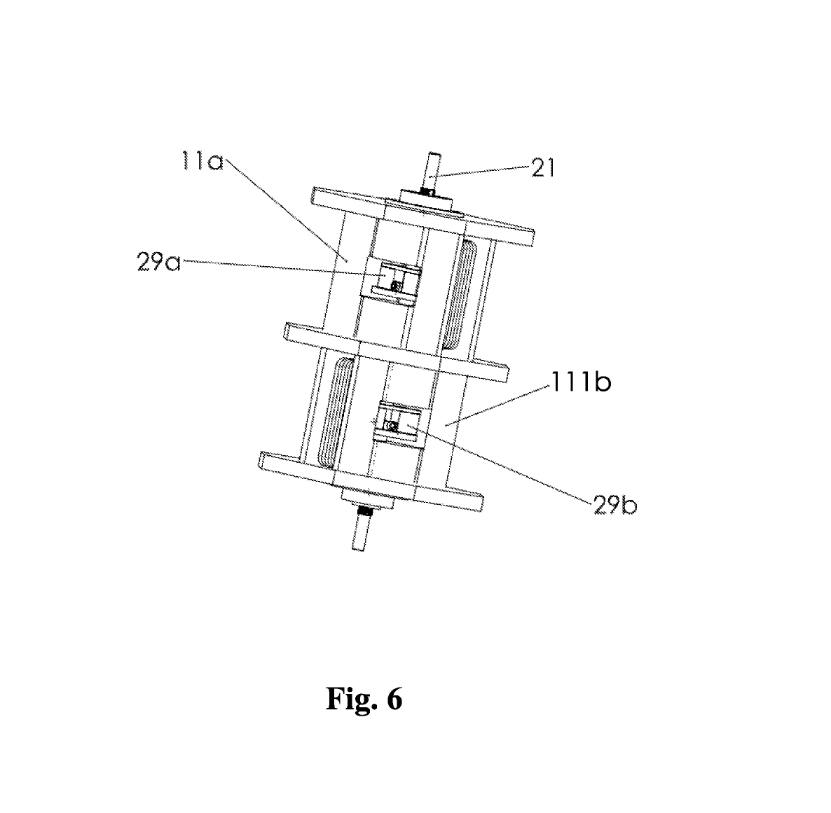

In a fourth embodiment of the motor of the invention shown in FIG. 6, two diametric coil units 11a and 111a are provided 90° one with respect to the other. The rotor 20 is in fact a two level rotor, i.e., each of the disk and permanent magnets rotor arrangements (of FIGS. 2b, 3, and 4a, respectively) is doubled in two rotor-levels 29a and 29b, respectively. Moreover, the components (coil unit and permanent magnets) of the lower level 29b are arranged 90° relative those corresponding components of rotor's upper level 29a. DC currents are provided to the coils of the two coil units 11a and 111a. Although the rate of the current-direction inversions in the structure of the fourth embodiment is doubled compared to the rate in the first, second and third embodiments, still the structure of the motor remains very simple, in view of the use of diametric coil units.

As previously mentioned, the typical electrical motors of the prior art suffer from a significant parasitic magnetic flux, which results in the generation of a reversed EMF (CEMF), in addition to the forward EMF that the motor is intended to produce. Such a generation of a parasitic electrical force results in a significant loss of energy.

The motor of the present invention very significantly reduces such losses of energy, while using a relatively low current and a relatively high voltage supply. As noted, in a preferred embodiment of the invention two ferromagnetic (e.g., iron) arcuate pieces 28a and 28b (or 128a and 128b) are disposed between respective two permanent magnets 24a and 24b (or 124a and 124b), as shown in FIGS. 2b and 3. Alternatively, the ferromagnetic disk of FIG. 4a serves the same purpose. Therefore, the set of permanent magnets, together with the two ferromagnetic arcuate pieces or disk 225, form a circular structure which passes through the cavity 14 of bobbin units 11, respectively, allowing a free rotation of the rotor disk. As noted, it has been found that the added ferromagnetic pieces (or disk 225) in between the pair of permanent magnets is very important, as this structure contributes to a very significant reduction to the parasitic CEMF compared to the prior art. The same effect is obtained also in the fourth embodiment that comprises two coil units 11 arranged in 90° one with respect to the other, in two rotor-levels, respectively.

As noted, it has been found that in all the four embodiments of the motor of the invention, the parasitic magnetic losses, namely the CEMF, is extremely low compared to equivalent motors of conventional prior art structures. While in conventional motors the level of the CEMF typically reaches 80%-90%, the level of the CEMF in the motor of the invention has been found to be between 10% to 12%.

### EXAMPLE

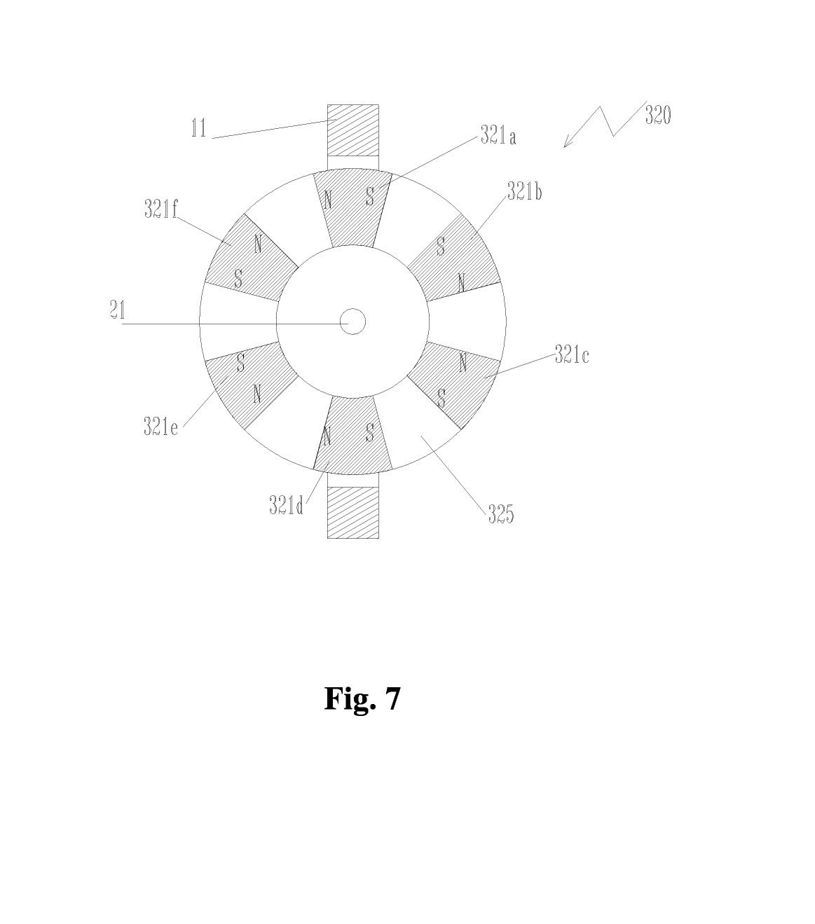

A motor according to the invention was implemented, in a structure as shown in FIG. 7. The motor comprised of a single diametric coil unit 11, and six permanent magnets 321a-321f. Six iron pieces 325 were disposed between each pair of permanent magnets. More specifically:
1. Rotor structure: a one level structure as shown in FIG. 7;
2. Number of diametric coil units: 1;
3. Number of permanent magnets: 6;
4. Number of iron pieces between each pair of permanent magnets: 6;
5. Number of windings in each coil: 10-20;
6. Diameter of the wire that was used in the coil of the coil unit: 10 mm (LITZ);
7. The level of the voltage supply: 6-8 VDC;
8. The level of the current: 300-400 A;
9. The power of the motor: up to 20 KW;
10. The number of rounds per minutes achieved: up 20,000 rpm;
11. The diameter of the disk: up to 300 mm.

For the above moto structure, the CEMF at a speed of 3000 rpm has been found to be no more than 10%.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. An electric motor comprising:
(A) a disk-type rotor which comprises:
a. a co-centric shaft and disk;
b. two or more permanent magnets on top or within said disk; and
c. pieces of ferromagnetic material that are disposed between at least two of said permanent magnets;
and,
(B) a stator which comprises:
d. a diametric coil unit which is disposed along a diameter of the rotor's disk, the coil unit comprises:
(d1) a diametric rectangular bobbin having a rectangular cavity, said rectangular cavity having a length slightly larger than the diameter of the rotor;
(d2) a coil which is wounded around said diametric bobbin; and
(d3) upper and lower holes within said bobbin to contain said shaft, thereby to allow rotation of said rotor within the said rectangular cavity.

2. An electric motor according to claim 1, wherein said rotor comprises a non-ferromagnetic lower disk, and wherein said permanent magnets are equi-angularly spaced and equi-radially disposed on said lower disk in a partial ring-like structure, and wherein ferromagnetic-material pieces are disposed between at least two of said permanent magnets to form a partial or closed ring-like structure.

3. An electric motor according to claim 2, wherein when two of said permanent magnets are used, they are disposed along a diameter of said lower disk.

4. An electric motor according to claim 2, wherein similar poles of the permanent magnets face one another, respectively.

5. An electric motor according to claim 2, wherein when a partial ring-like structure is formed, an air space is provided between each of one or more pairs of permanent magnets.

6. An electric motor according to claim 2, which further comprises an upper disk of non-ferromagnetic material, for strengthening the structure of the rotor.

7. An electric motor according to claim 1, wherein said disk-type rotor comprises a ferromagnetic-material disk, wherein said two or more permanent magnets are equi-angularly spaced and equi-radially disposed within dedicated slots in said disk.

8. An electric motor according to claim 1, further comprising a motor controller for periodically alternating a direction of a DC current which is supplied to said coil.

9. An electric motor according to claim 8, further comprising one or more angular orientation sensors, for feeding a respective orientation signal into said motor controller.

10. An electric motor according to claim 9, wherein said one or more angular orientation sensors are disposed on the motor's shaft.

11. An electric motor according to claim 9, wherein said one or more angular orientation sensors are disposed within the bobbin of the diametric coil unit.

12. An electric motor according to claim 1, which comprises a two level rotor, wherein all the components of the second rotor-level, including its permanent magnets and its diametric coil are shifted 90° relative to similar components in the first rotor's level.
